(19) United States
(12) Patent Application Publication
(10) Pub. No.: US 2023/0118054 A1
(43) Pub. Date: Apr. 20, 2023

(54) SWITCHABLE CLUTCH ASSEMBLY INCLUDING DISPLACEABLE CAGE

(71) Applicant: Schaeffler Technologies AG & Co. KG, Herzogenaurach (DE)

(72) Inventor: Peter Saeckl, Wooster, OH (US)

(73) Assignee: Schaeffler Technologies AG & Co. KG, Herzogenaurach (DE)

(21) Appl. No.: 17/506,209

(22) Filed: Oct. 20, 2021

(51) Int. Cl. F16D 41/12

(52) U.S. Cl. CPC F16D 41/12

(57) ABSTRACT

A clutch assembly is disclosed. The clutch assembly generally includes an inner ring and an outer ring. In one aspect, a first one of the inner or outer ring includes a first plurality of engagement elements, and a second one of the inner or outer ring includes a second plurality of engagement elements that are configured to selectively engage with the first plurality of engagement elements. A cage is arranged between the inner ring and the outer ring. The cage defines pockets configured to selectively receive the second plurality of engagement elements. An actuator assembly is configured to selectively displace the cage to either rotationally connect or disconnect the two rings from each other based on a relative position of the cage.

### FIELD OF INVENTION

The present disclosure is directed to a switchable clutch assembly, and is more particularly related to a clutch assembly with a displaceable cage.

### BACKGROUND

Clutch assemblies, such as one-way clutch assemblies, are well known. In some assembly configurations, it is common to include rockers on a first ring that are configured to selectively engage with ramps on a second ring. Some known types of clutch assemblies require one of the rings to be fixed, which is limiting and disadvantageous for certain arrangements or configurations.

It would be desirable to provide a more adaptable clutch assembly that reduces the complexity associated with installation, assembly, and alignment.

### SUMMARY

In one aspect, a clutch assembly is disclosed. The clutch assembly generally includes an inner ring and an outer ring. In one aspect, a first one of the inner or outer ring includes a first plurality of engagement elements, and a second one of the inner or outer ring includes a second plurality of engagement elements that are configured to selectively engage with the first plurality of engagement elements. A cage is arranged between the inner ring and the outer ring. The cage defines pockets configured to selectively receive the second plurality of engagement elements. An actuator assembly is configured to selectively displace the cage to either rotationally connect or disconnect the two rings from each other based on a relative position of the cage.

In one aspect, the pockets on the cage can be positioned closer to one axial end of the cage than an opposite axial end of the cage.

The actuator assembly can generally include an actuator configured to displace the cage in a first axial direction. The actuator assembly can include a biasing element configured to bias the cage in a second axial direction that is opposite the first axial direction.

In one aspect, the first plurality of engagement elements are ramps or notch teeth and the second plurality of engagement elements are rockers.

In one aspect, the pockets can be aligned with the rockers such that the inner ring and the outer ring are rotationally connected with each other in an actuated state, and the pockets are offset from the rockers such that the inner ring and the outer ring are not rotationally connected with each other in a non-actuated state. In another aspect, the pockets are aligned with the rockers such that the inner ring and the outer ring are rotationally connected with each other in a non-actuated state, and the pockets are offset from the rockers such that the inner ring and the outer ring are not rotationally connected with each other in an actuated state.

In one aspect, the outer ring includes the ramps or notch teeth, and the inner ring includes the rockers. In another aspect, the outer ring includes the rockers and the inner ring includes the ramps or notch teeth.

The rockers can include a ramped or tapered surface configured to engage with an internal axial surface of the cage. In one aspect, the ramped or tapered surface of the rockers can be defined on an axial or lateral side.

The actuator assembly can include a lever arm configured to be pivotally engaged by an actuator to selectively displace the cage.

The actuator assembly can generally be configured to directly engage an axial end face of the cage.

In one aspect, a quantity of the rockers corresponds to a quantity of the pockets. One of ordinary skill in the art would understand that the quantity of rockers and pockets can differ from each other.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a perspective view of a portion of a cage for a clutch assembly according to one aspect.

FIG. 2A is a perspective view of a portion of the clutch assembly in a non-actuated state.

FIG. 2B is a perspective view of the portion of the clutch assembly from FIG. 2A in an actuated state.

FIG. 3A is a perspective view of a portion of another clutch assembly in a non-actuated state.

FIG. 3B is a perspective view of the portion of the clutch assembly of FIG. 3A in an actuated state.

FIG. 4A is a side view of a clutch assembly showing a rocker engaging with a notch tooth.

FIG. 4B is a side vide of the clutch assembly of FIG. 4A with the rocker disengaged from the notch tooth.

FIG. 5A is an alternative clutch assembly showing a rocker on an outer ring engaging with a notch tooth on an inner ring.

FIG. 5B is another view of the clutch assembly of FIG. 5A with the rocker on the outer ring disengaged from the notch tooth on the inner ring.

FIG. 6 is a schematic view of a portion of a clutch assembly illustrating one aspect of an actuator assembly.

FIG. 7 is a view of another type of actuator assembly for the clutch assembly.

FIG. 8 is a top view of a rocker according to one aspect.

### DETAILED DESCRIPTION OF THE PREFERRED EMBODIMENTS

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

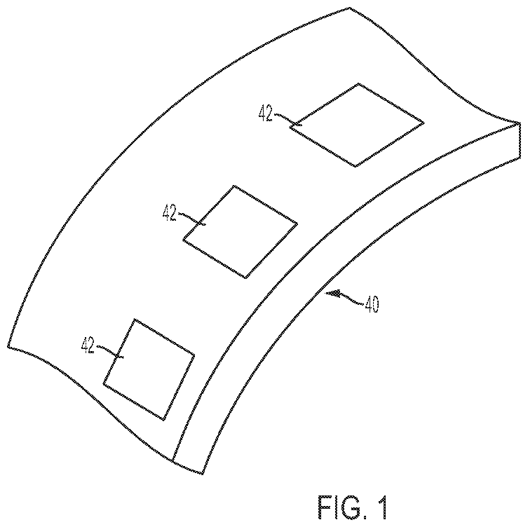

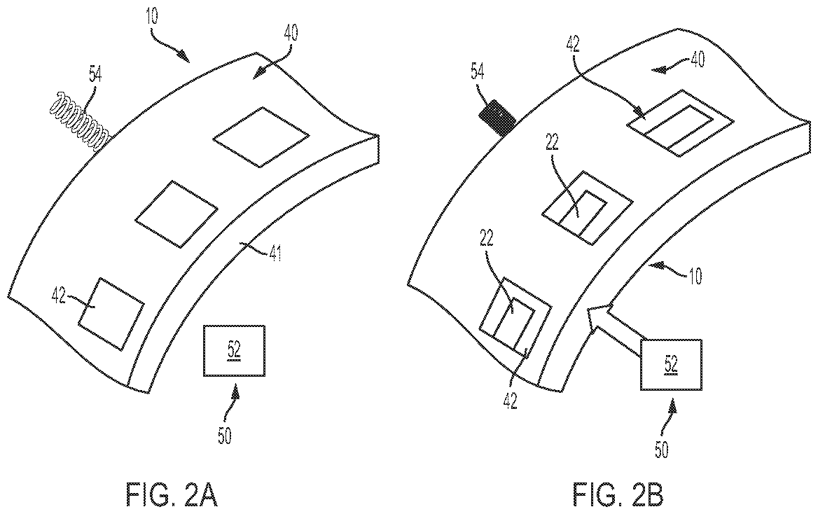

FIG. 1 illustrates a cage 40 for use in a clutch assembly 10, 110, which is generally illustrated in FIGS. 2A, 2B, 3A, 3B, 4A, 4B, 5A, and 5B. The clutch assembly 10 includes a first ring or inner ring 20 and a second or outer ring 30. The cage 40 is generally configured to be displaced in order to either rotationally lock the inner and outer rings 20, 30 or to allow the inner and outer rings 20, 30 to freely rotate relative to each other.

In one aspect, a first one of the inner ring 20 or the outer ring 30 includes a first plurality of engagement elements and a second one of the inner ring 20 or the outer ring 30 includes a second plurality of engagement elements. In one aspect, the first plurality of engagement elements are notch teeth or ramps 32 and the second plurality of engagement elements are biased rockers 22. As used herein, the term notch tooth or teeth can refer to any type of indentation, recess, or receptacle. In one aspect, the notch teeth are formed as ramped surfaces or receptacles. The profiles, dimensions, depth, shape, etc. of the notch teeth or ramps can vary.

The shape and configuration of the first and second plurality of engagement elements can vary. For example, the engagement elements could include any pair of elements that are configured to mate or engage with each other.

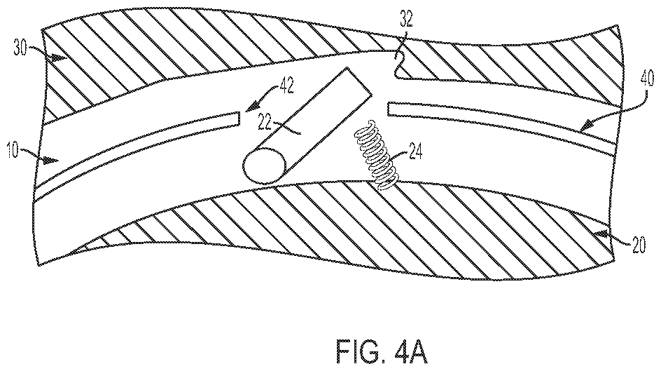

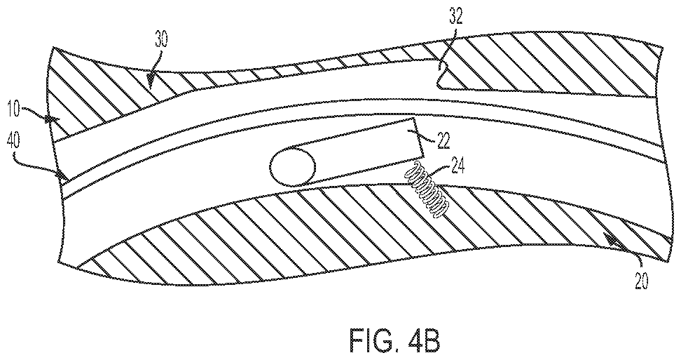

As shown in FIGS. 4A and 4B, the outer ring 30 can include the notch teeth 32 and the inner ring 20 can include the rockers 22 and associated biasing elements 24. As shown in FIGS. 5A and 5B, the outer ring 30 alternatively can include the rockers 122 and the biasing elements 124, and the inner ring 120 can define the notch teeth 132.

In one aspect, the clutch assembly disclosed herein is a one-way clutch. For example, as shown in FIGS. 4A and 4B, counter-clockwise rotation of the inner ring 20 provides a freewheel mode in which the inner ring 20 and the outer ring 30 can freely rotate relative to one another. In contrast, when the inner ring 20 is rotated in the clockwise direction, the rockers 22 are biased outwardly and catch the notch teeth 32, and therefore the inner ring 20 and the outer ring 30 are rotationally linked or locked relative to each other. One of ordinary skill in the art would understand that other types of arrangements can be provided.

The cage 40 is arranged between the inner ring 20 and the outer ring 30. The cage 40 can be arranged in a radial space defined between the inner ring 20 and the outer ring 30. The cage 40 defines a plurality of pockets 42 configured to selectively receive the biased rockers 22. In other words, the pockets 42 define passages that allow the biased rockers 22 to extend through the cage 40. The pockets 42 are spaced apart from each other in a circumferential direction. In one aspect, the pockets 42 are defined as rectangular openings. The exact shape and size of the pockets 42 can vary.

An actuator assembly 50 is configured to selectively displace the cage 40. Preferably, the actuator assembly 50 displaces the cage 40 in an axial direction. The actuator assembly 50 can be provided in a variety of different configurations and generally is configured to provide a predetermined axial force to the cage 40 to displace the cage 40.

The actuator assembly 50 is configured to (i) displace the cage 40 to a first position to align the plurality of pockets 42 with the plurality of rockers 22 such that the inner ring 20 and the outer ring 30 are rotationally connected with each other, and (ii) displace the cage 40 to a second position to offset the plurality of pockets 42 from the plurality of rockers 22 such that the inner ring 20 and the outer ring 30 are not rotationally connected with each other.

In one aspect, a plurality of springs or biasing elements 24 are configured to engage with the plurality of rockers 22. The springs 24 can generally be configured to bias the rockers 22 inward or outward and towards the pockets 42 of the cage 40.

In one aspect, the plurality of pockets 42 of the cage 40 are positioned closer to a first axial edge of the cage 40 than a second axial edge of the cage 40. In another aspect, the pockets 42 can be arranged in a medial region of the cage 40.

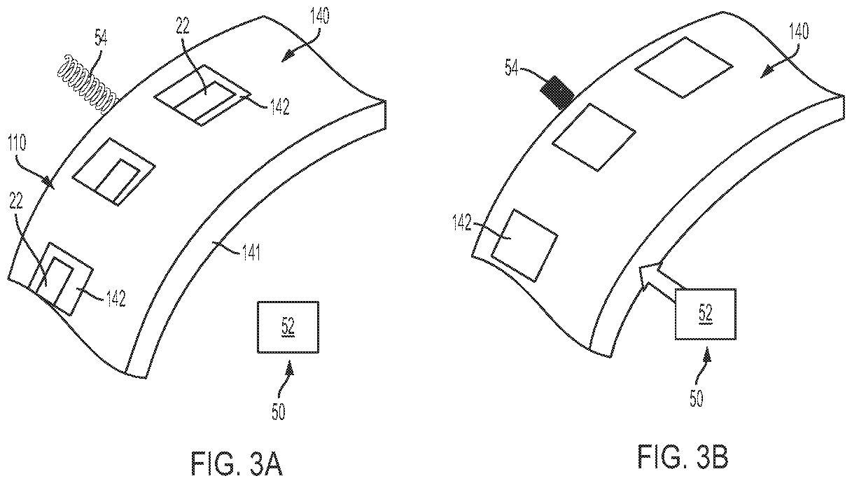

The actuator assembly 50 can include an actuator 52 configured to displace the cage 40 in a first axial direction, and a biasing element 54 configured to displace the cage 40 in a second axial direction that is opposing the first axial direction. The actuator 52 can be provided in any variety of configurations and arrangements. For example, the actuator 52 can include any type of linear, solenoid, piston, pneumatic, or other types of actuator. An arrow is shown protruding from the actuator 52 in FIGS. 2B and 3B for illustrative purposes only. The arrow in FIGS. 2B and 3B could represent a pin, lever, finger, or other type of mechanical element that is configured to engage a portion of the cage 40. In one aspect, the actuator assembly 50 is configured to contact or engage with an axial end face or surface 41 of the cage 40. Contact between the actuator assembly 50 and the cage 40 can either be direct (i.e. surface to surface) or indirect (i.e. intermediate components can be arranged between the actuator assembly and the cage).

As shown in FIGS. 2A and 2B, in one aspect, the plurality of pockets 42 are aligned with the plurality of rockers 22 such that the inner ring 20 and the outer ring 30 are rotationally connected with each other in an actuated state, and the plurality of pockets 42 are offset from the plurality of rockers 22 such that the inner ring 20 and the outer ring 30 are not rotationally connected with each other in a non-actuated state. In one aspect, as shown by FIG. 2B, a quantity of the rockers 22 corresponds to a quantity of the pockets 42.

In another aspect shown in FIGS. 3A and 3B, a different configuration for the actuated and non-actuated state can be provided. In FIGS. 3A and 3B, the plurality of pockets 142 are aligned with the plurality of rockers 22 such that the inner ring 20 and the outer ring 30 are rotationally connected with each other in a non-actuated state (i.e. FIG. 3A), and the plurality of pockets 142 are offset from the plurality of rockers 22 such that the inner ring 20 and the outer ring 30 are not rotationally connected with each other in an actuated state (i.e. FIG. 3B). The cage 140 differs from the cage 40 in that the pockets 142 are defined closer to an opposite axial side than the pockets 42 of the cage 40.

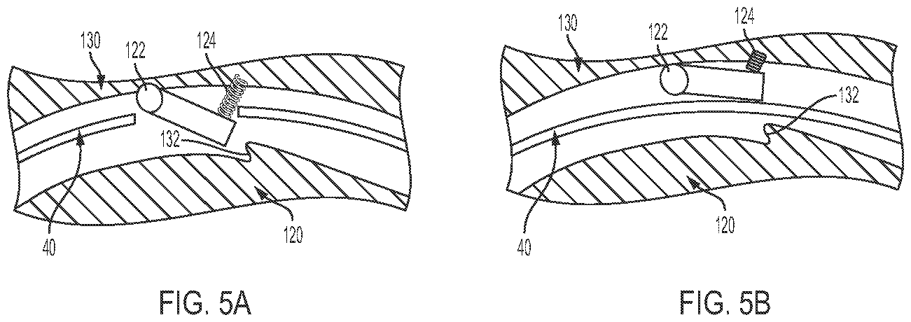

As shown in FIG. 6, an alternative configuration for the actuator assembly 50′ is provided. As shown in FIG. 6, the actuator assembly 50′ includes more than one actuator 52a, 52b. Each of the actuators 52a, 52b can include an associated biasing element 54a, 54b. The actuators 52a, 52b can be provided at different circumferential positions relative to the cage 40. This arrangement ensures that uniform displacement force is applied to the cage. In one aspect, the actuator assembly 50′ can include a ring-shaped actuator that engages an entire circumference of the cage 40. In one aspect, more than two actuators 52a, 52b can be provided. The actuators can be arranged at equal circumferential spacing from each other.

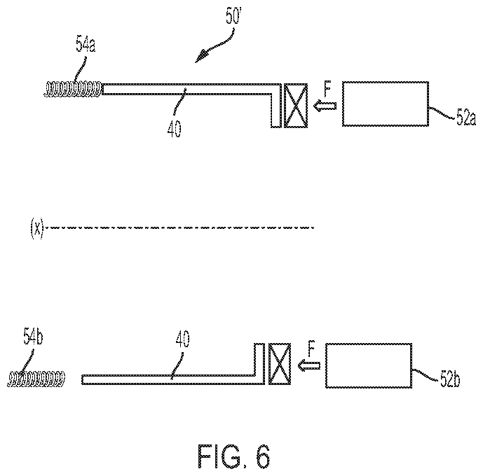

As shown in FIG. 7, the actuator assembly 150 can include a lever arm 151 configured to be pivotally engaged by an actuator 152 to selectively displace the cage 40. One of ordinary skill in the art would understand that any type of actuator could be used to impar the axially displacing force on the cage, and the orientation of the actuator can vary.

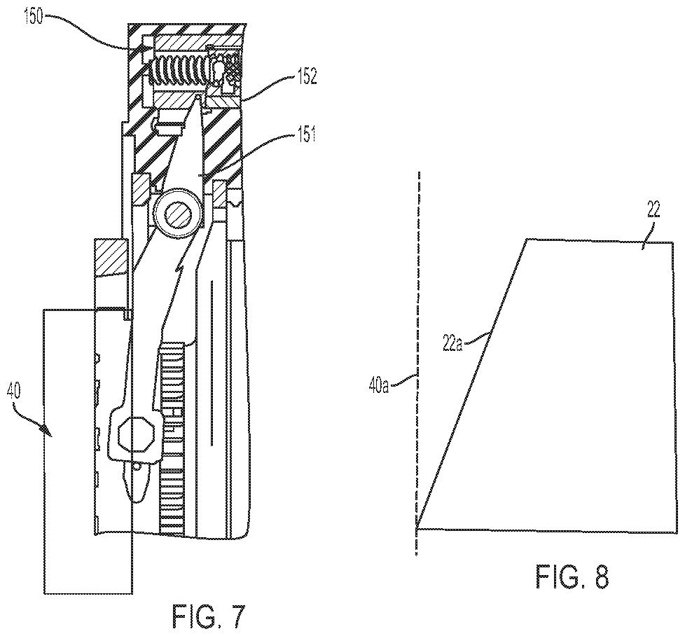

As shown in FIG. 8, the plurality of rockers 22 can include a tapered or ramped surface 22a configured to engage with the cage 40. In one aspect, the tapered surface 22a is a lateral surface. The profile, shape, size, etc., of the rockers 22 can be modified to provide improved engagement surfaces with the cage 40. As shown in FIG. 8, an internal surface or sidewall 40a of the cage 40 is arranged adjacent to the tapered surface 22a of the rocker 22. By tapering a profile of the surface 22a, the amount of surface contact between the cage 40 and the rocker 22 is reduced. Furthermore, if the surface is straight, the cage cannot put down the rocker because the side of the pocket engage against the rocker. By including a tapered side surface on the rocker, the cage can engage and drive the rocker downward more efficiently and reliably.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

Clutch assembly 10, 110
Inner ring 20, 120
Second plurality of engagement elements/Biased rockers 22, 122
Tapered surface 22a of rocker
Spring/Biasing element 24, 124
Outer ring 30, 130
First plurality of engagement elements/notch teeth 32, 132
Cage 40, 140
Internal surface 40a of cage
Axial end face 41, 141 of the cage 40, 140
Pockets 42, 142
Actuator assembly 50, 50′, 150
Actuator 52, 52a, 52b
Linkage 53
Biasing element 54
Lever arm 151
Actuator 152

What is claimed is:

1. A clutch assembly comprising:
an inner ring and an outer ring, wherein a first one of the inner ring or the outer ring includes a first plurality of engagement elements and a second one of the inner ring or the outer ring includes a second plurality of engagement elements configured to be selectively engaged with the first plurality of engagement elements;
a cage arranged between the inner ring and the outer ring, the cage defining a plurality of pockets configured to selectively receive the second plurality of engagement elements such that the second plurality of engagement elements extend radially through the cage; and
an actuator assembly configured to selectively displace the cage between:
(i) a first position to align the plurality of pockets with the second plurality of engagement elements such that the inner ring and the outer ring are rotationally connected with each other, and
(ii) a second position to offset the plurality of pockets from the second plurality of engagement elements such that the inner ring and the outer ring are not rotationally connected with each other.

2. The clutch assembly according to claim 1, wherein the first plurality of engagement elements are notch teeth, and the second plurality of engagement elements are biased rockers.

3. The clutch assembly according to claim 2, wherein the outer ring includes the notch teeth and the inner ring includes the biased rockers.

4. The clutch assembly according to claim 2, wherein the outer ring includes the biased rockers and the inner ring includes the notch teeth.

5. The clutch assembly according to claim 2, further comprising a plurality of biasing elements configured to engage the biased rockers.

6. The clutch assembly according to claim 2, wherein the biased rockers include a tapered surface configured to engage with an internal axial surface of the cage.

7. The clutch assembly according to claim 1, wherein the plurality of pockets of the cage are positioned closer to a first axial edge of the cage than a second axial edge of the cage.

8. The clutch assembly according to claim 1, wherein the actuator assembly includes an actuator configured to displace the cage in a first axial direction, and a biasing element configured to bias the cage in a second axial direction that is opposite the first axial direction.

9. The clutch assembly according to claim 1, wherein the plurality of pockets are aligned with the second plurality of engagement elements such that the inner ring and the outer ring are rotationally connected with each other in an actuated state of the actuator assembly, and the plurality of pockets are offset from the second plurality of engagement elements such that the inner ring and the outer ring are not rotationally connected with each other in a non-actuated state of the actuator assembly.

10. The clutch assembly according to claim 1, wherein the plurality of pockets are aligned with the second plurality of engagement elements such that the inner ring and the outer ring are rotationally connected with each other in a non-actuated state of the actuator assembly, and the plurality of pockets are offset from the second plurality of engagement elements such that the inner ring and the outer ring are not rotationally connected with each other in an actuated state of the actuator assembly.

11. The clutch assembly according to claim 1, wherein the actuator assembly includes a lever arm configured to be pivoted by an actuator and selectively displace the cage.

12. The clutch assembly according to claim 1, wherein the actuator assembly is configured to contact an axial end face of the cage.

13. The clutch assembly according to claim 1, wherein a quantity of the second plurality of engagement elements corresponds to a quantity of the plurality of pockets.

14. A clutch assembly comprising:
an inner ring and an outer ring, a first one of the inner ring or the outer ring defining a plurality of notch teeth and a second one of the inner ring or the outer ring including a plurality of biased rockers configured to be biased to selectively engage with the plurality of notch teeth;
a cage arranged between the inner ring and the outer ring, the cage defining a plurality of pockets configured to selectively receive the plurality of biased rockers such that the plurality of biased rockers extend radially through the cage; and
an actuator assembly configured to selectively displace the cage in an axial direction to selectively engage and disengage the plurality of rockers with the plurality of notch teeth based on a relative axial position of the cage.

15. The clutch assembly according to claim 14, wherein the biased rockers include a tapered surface on a lateral side that is configured to engage with an internal axial surface of the cage.

16. The clutch assembly according to claim 14, wherein the plurality of pockets of the cage are positioned closer to a first axial edge of the cage than a second axial edge of the cage.

17. The clutch assembly according to claim 14, wherein the actuator assembly includes an actuator configured to displace the cage in a first axial direction, and a biasing element configured to bias the cage in a second axial direction that is opposite the first axial direction.

18. The clutch assembly according to claim 14, wherein the plurality of pockets are aligned with the plurality of biased rockers such that the inner ring and the outer ring are rotationally connected with each other in an actuated state of the actuator assembly, and the plurality of pockets are offset from the plurality of biased rockers such that the inner ring and the outer ring are not rotationally connected with each other in a non-actuated state actuator assembly.

19. The clutch assembly according to claim 14, wherein the plurality of pockets are aligned with the plurality of biased rockers such that the inner ring and the outer ring are rotationally connected with each other in a non-actuated state actuator assembly, and the plurality of pockets are offset from the plurality of biased rockers such that the inner ring and the outer ring are not rotationally connected with each other in an actuated state actuator assembly.

20. The clutch assembly according to claim 14, wherein the actuator assembly includes a plurality of actuators that are circumferentially spaced from each other and each configured to displace the cage.
